(19) United States
(12) Patent Application Publication
(10) Pub. No.: US 2018/0043646 A1
(43) Pub. Date: Feb. 15, 2018

(54) METHOD OF POWER TRANSMISSION TO CONTACT LENS AND SYSTEM USING THE SAME

(71) Applicant: UBIQUITY BIOMEDICAL CORPORATION, Taipei City (TW)

(72) Inventors: Horng-Ji LAI, Taipei City (TW); Wan-Ting CHIOU, Taipei City (TW); Kuan-Ting YEH, Taipei City (TW); Shun-Hsi HSU, Taipei City (TW)

(73) Assignee: UBIQUITY BIOMEDICAL CORPORATION

(21) Appl. No.: 15/650,030

(22) Filed: Jul. 14, 2017

(30) Foreign Application Priority Data
Aug. 11, 2016 (TW) 105125559

(51) Int. Cl. B29D 11/00; H02J 50/10; H04B 5/00; G02C 7/04

(52) U.S. Cl. CPC B29D 11/00826; G02C 7/04; H02J 50/10; H04B 5/0037; G02C 11/10

(57) ABSTRACT

A system of power transmission to a contact lens comprises a contact lens and a magnetic component. The contact lens comprises at least a physiological signal sensing component, an induction coil, and an energy storage component. When the magnetic component has a motion relative to the induction coil, an induced voltage is produced in the induction coil for charging the energy storage component.

### CROSS-REFERENCE TO RELATED APPLICATION

This application claims priority from Taiwan Patent Application No. 105125559 filed on Aug. 11, 2016, which are hereby incorporated herein by reference in its entirety.

### BACKGROUND OF THE INVENTION

### 1. Field of the Invention

The invention relates to a contact lens capable of receiving electrical energy from its exterior, and particularly, to a method of power transmission to a contact lens and a system using the same.

### 2. Description of Related Art

A contact lens is a lens placed on the cornea of an eye for vision correction or eye protection. When the miniature technology of electrical devices has been gradually mature, a contact lens is used not only to correct vision but also to sense the physical properties of an eye or mechanical substances in tears by a miniaturized electrical device which is embedded into the contact lens. Thus, a user can understand the health of his eyes or body. For example, a control circuit, a microprocessor, a communication device, a power supply, a sensor, an actuator, an LED, a photoelectrical sensor, or a miniaturized antenna is integrated with a contact lens so that the contact lens can be used to correct vision and further improve vision. Furthermore, it can yield additionally functional results.

The foregoing miniaturized electrical device needs to consume electrical power for its normal operation. Accordingly, it is an important and unresolved problem that sufficient electrical power is effectively supplied to the contact lens. For example, U.S. publication patent application US2013/0041245 A1 disclosed an assembly of a contact lens and a pressure sensor capable of long-termly measuring intraocular pressure. The assembly embeds a resistance pressure sensor, an antenna, and a sensing chip into the contact lens. Such assembly of the contact lens is worn on the cornea of an eye. The electrical power is transmitted to the assembly of the contact lens by near field coupling. Accordingly, an antenna capable of transmitting data and electrical power is attached to the surrounding (i.e. an eye socket) of an eye for a tester. Moreover, the antenna is in electrical communication with a portable record apparatus by an electrical wire, and is capable of being powered by the portable record apparatus to generate an electromagnetic field with sufficient sensitivity. Thus, a required coupling current is induced in the antenna of the contact lens. However, when the apparatus and the antenna mounted to the eye socket simultaneously operate, the surrounding of the eye of the tester exists in the electromagnetic field with a certain power density so that a chronic injury is caused to the delicate eye. Furthermore, the electrical wire wraps tester's body so that he moves with some difficulty.

Also, U.S. Pat. No. 8,096,654 B2 disclosed a contact lens whose interior has an image display, several processing chips, an energy transfer antenna, and biosensors. In addition to the contact lens, a radio frequency communication apparatus and a power supply apparatus are necessarily provided at a far side. Such a contact lens can be applied to image display, biomedical sensing or related uses. It consumes the power externally from the power supply apparatus which electrically powers the contact lens in a far-field transferring energy way. Likewise, a tester needs to wear an additional apparatus, and exists a high power electromagnetic environment so that his eye and body may have quite injuries.

In view of above, the users are in very need of a safe and compact energy transfer apparatus capable of energy harvest (harvesting energy from the external of the system or apparatus and transferring it to electrical energy) and a contact lens with circuits which simultaneously operate. It can be broadly applied to preventive medicine and correctional health.

### SUMMARY OF THE INVENTION

The present application provides a method of power transmission to a contact lens and a system using the same. Electrical energy is generated to power electrical components within a contact lens by physical motion based on the electromagnetic induction theory.

In view of above aspects, the present invention provides a system of power transmission to a contact lens which comprises a contact lens comprising at least a physiological signal sensing component, an induction coil, and an energy storage component electrically connected to the physiological signal sensing component and the induction coil; and a magnetic component, wherein an induction electromotive force is produced in the induction coil for charging the energy storage component when the magnetic component has a motion relative to the induction coil.

In an embodiment, the magnetic component comprises a material capable of generating magnetic lines. The magnetic component is disposed on the surface of an upper lid.

In an embodiment, the contact lens comprises a transparent material. The physiological signal sensing component, the induction coil, and the energy storage component are embedded into the transparent material.

In an embodiment, the induction coil is an antenna for transmitting wireless signals. The system comprises a receiving analyzer for receiving and analyzing the wireless signals from the antenna.

In an embodiment, the physiological signal sensing component is used to measure the intraocular pressure, humidity, temperature, pH, or the composition of tears for an eye. The contact lens further comprises a power management circuit. The power management circuit conducts rectification, voltage limitation, and voltage stabilization (regulation) for the induction electromotive force, and stores processed electrical energy in the energy storage component.

In an embodiment, the contact lens further comprises a transceiver and processer circuit including: a signal reading circuit capturing electrical signals generated from the physiological signal sensing component; a processor converting the electrical signals into processed signals; a modulator adapting the impedance of the induction coil to control the induction coil for generating the induction electromotive force, receiving high frequency wireless signals from an exterior or transmitting wireless signals to the exterior or being capable of converting the processed signals into high frequency wireless signals for feeding the induction coil them to transmit outwardly; and a demodulator receiving the high frequency wireless signals received by the induction coil from the exterior and recovering the high frequency wireless signals to low frequency signals for transmitting them to the processor.

In an embodiment, the energy storage component is a capacitor, an inductor, or a battery.

The present invention further provides a method for transmitting electrical energy to a contact lens comprising the steps of: providing a contact lens with an induction coil and a magnetic component; and moving the magnetic component relative to the induction coil in a manner that an induction electromotive force is produced in the induction coil.

The present invention provides a system of power transmission to a contact lens which comprises a contact lens comprising at least a physiological signal sensing component and an induction coil; and a magnetic component, wherein an induction electromotive force is produced in the induction coil for powering the physiological signal sensing component when the magnetic component has a motion relative to the induction coil.

### BRIEF DESCRIPTION OF THE DRAWINGS

In order to sufficiently understand the essence, advantages and the preferred embodiments of the present invention, the following detailed description will be more clearly understood by referring to the accompanying drawings.

FIG. 1 is a schematic diagram of a contact lens in accordance with an embodiment of the present application;

FIG. 2 is a schematic diagram of a magnetic component in accordance with an embodiment of the present application;

FIG. 3A and FIG. 3B illustrate a schematic diagram of the contact lens of FIG. 1 worn on the surface of an eye and the magnetic component of FIG. 2 attached to an upper lid;

FIG. 4A and FIG. 4B illustrate the magnetic component having a motion relative to the induction coil in accordance with an embodiment of the present application;

FIG. 5 is the function block diagram of a circuitry within a contact lens in accordance with an embodiment of the present invention;

FIG. 6 is a schematic diagram of a system of power transmission to a contact lens in accordance with another embodiment of the present invention;

FIG. 7 is the function block diagram of a circuitry within a contact lens in accordance with another embodiment of the present invention.

### DETAILED DESCRIPTION OF THE INVENTION

The following description shows the preferred embodiments of the present invention. The present invention is described below by referring to the embodiments and the figures. Thus, the present invention is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

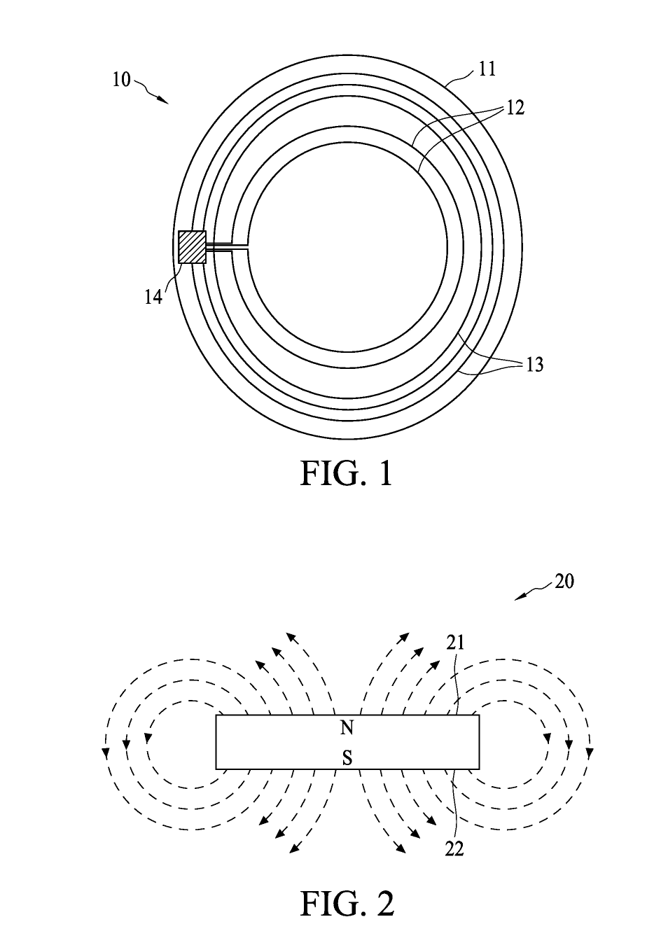

FIG. 1 is a schematic diagram of a contact lens in accordance with an embodiment of the present application. This embodiment illustrates a contact lens 10 with a temperature measurement function, but the application is not limited to this example. The concept may be applied to any wearable apparatus on the surface of an eye. The contact lens 10 mainly comprises a transparent substrate 11, a physiological signal sensing component (or a physiological signal sensing system) 12, an induction coil (or an antenna) 13 and a transceiver and processer circuit 14. The material of the transparent substrate 11 may be silicone hydrogel (e.g. Hydroxyethyl methacrylate (HEMA)) which has the advantages of high levels of oxygen permeability and hydrophily. Therefore, a user can feel more comfortable with the contact lens within a long period. The material of the transparent substrate 11 can be other transparent polymer materials, but is not limited to the example. The induction coil 13 can transmit wireless signals outwards and also can receive external energy. For example, magnetic induction is produced by an external magnetic component in the induction coil 13 so that electrical energy which is accordingly generated powers the physiological signal sensing component 12 and a transceiver and processer circuit 14. The electrical energy may be directly or indirectly (e.g. through a power management circuit) supplied to the two components. More detailed explanations are described in the embodiments below.

The physiological signal sensing component 12 may an ASIC (Application-Specific IC), a MEMS device, or a sensing device formed by a nano or peco chemical material, metal material or bio material. They can be used to measure the intraocular pressure, humidity, temperature, pH, or the composition (e.g. blood glucose) of tears. Various sensors with different uses or types may be applied to the embodiment, and include active devices and passive devices. The former ones including active circuits consume more power, and the later ones consume quite less power. The sufficient power is provided to the devices based on their requirements, and otherwise, the devices cannot read sensing signals or normally perform. The transceiver and processer circuit 14 can convert the electrical signals (e.g. voltage signals or current signals) generated from the physiological signal sensing component 12 to radio frequency (RF) signals, and wireless signals are transmitted outwards by the antenna 13. The application is not limited to the conversion from the electrical signals to the RF signals. The electrical signals may be converted to signals Bluetooth conforming to Bluetooth or WiFi protocols. Similar to the foregoing ring-like wirings, the antenna 13 is coated on the surface of the transparent substrate 11 and disposed outside the temperature sensing device as several ring-like wirings. It transmits wireless signals conforming to a communication protocol outwards.

The foregoing magnetic component comprises a material capable of generating magnetic lines. Therefore, the induction coil 13 cuts the magnetic lines, and an induction electromotive force is produced in the induction coil 13. The induction coil 13 is made in an electrically close loop so that an induced voltage is accordingly produced by the induction electromotive force. FIG. 2 is a schematic diagram of a magnetic component in accordance with an embodiment of the present application. A magnetic component 20 includes an N pole 21 and S pole 22. The magnetic lines leave from the N pole 21, go through ambient air, and come in the S pole 22. Then, the lines pass the interior of the magnetic component 20 and reach the N pole 21 repeatedly.

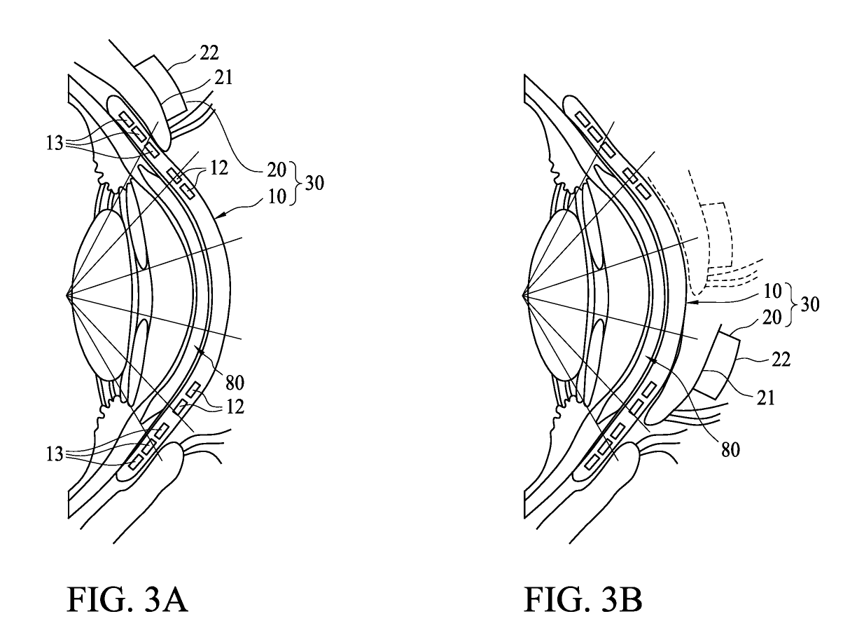

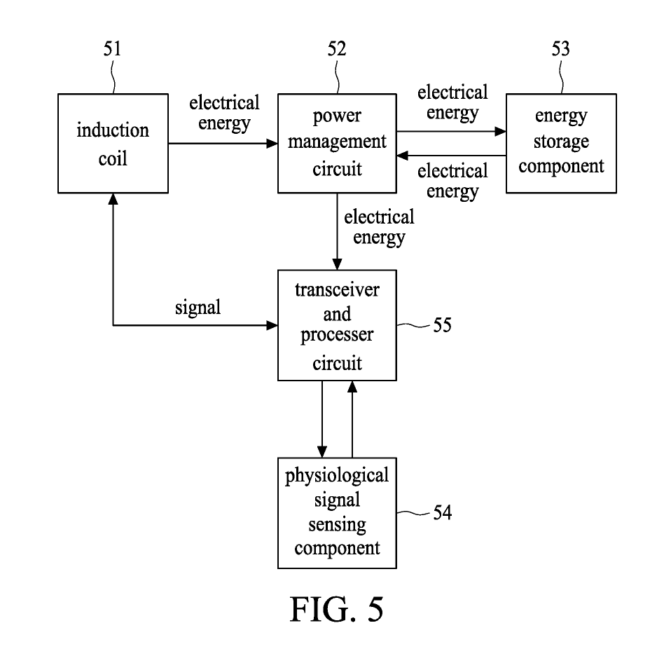

FIG. 3A and FIG. 3B illustrate a schematic diagram of the contact lens of FIG. 1 worn on the surface of an eye and the magnetic component of FIG. 2 attached to an upper lid. As shown in FIG. 3A, when an eye is open, the magnetic component 20 is attached to an upper lid and is above the upper rim of the contact lens 10 worn on an eyeball 80. The magnetic component 20 and the contact lens 10 are included in a system 30 for transmitting electrical energy to a contact lens. A normal person blinks about dozens of times per minute when awake. The upper lid moves towards the lower lid till they are temporally close or near during each blink. Therefore, the magnetic lines of the magnetic component 20 attached to the upper lid cross the induction coil 13, and are cut by the induction coil 13. Accordingly, an induction electromotive force is produced in the induction coil 13. Afterward the upper lid is away from the lower lid toward the upper portion of the eyeball 80. Similarly, the magnetic lines of the magnetic component 20 cross the induction coil 13 and are cut by it, but an induced voltage produced in the induction coil 13 is changed in its voltage direction. However, the different directions of induced voltages may charge and discharge an energy storage component (not shown) during a cycle of each blink. Therefore, a next embodiment (See FIG. 5) will propose a circuit to resolve such a discharge problem.

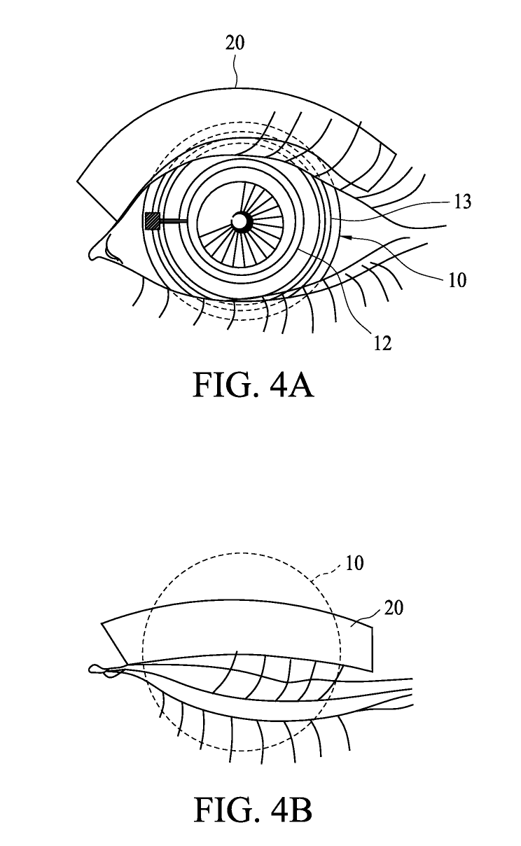

FIG. 4A and FIG. 4B illustrate the magnetic component having a motion relative to the induction coil in accordance with an embodiment of the present application. Compared with FIGS. 3A and 3B, these diagrams can clearly illustrate that the magnetic component 20 has a motion relative to the induction coil 13 of the contact lens 10 when a person blinks his eye. The average of person's blink is about dozens of times per minute. An induced voltage or energy is accordingly produced during each blink so as to power the physiological signal sensing component 12, the transceiver and processer circuit 14, and other power consuming components. For example, a power management component, a control circuit, a microprocessor, a communication component, a power supply, a sensor, a actuator, an LED, photosensor and so on (not shown; i.e. not limit to the embodiment as shown in FIG. 1) requires electrical power from the induced voltage or energy.

FIG. 5 is the function block diagram of a circuitry within a contact lens in accordance with an embodiment of the present invention. In view of above, induced voltages with different directions are produced in an induction coil (or antenna) 51 during a cycle of each blink. A power management circuit 52 can covert the induced voltages with different directions to a voltage with one direction through rectification, voltage limitation, and voltage stabilization. Thus, an energy storage component 53 can be effectively and fully charged. In this regard, there are no chances to discharge the energy storage component 53. The energy storage component 53 is a capacitor, an inductor, or a battery (MEMS miniature battery), and powers a physiological signal sensing component 54 and a transceiver and processer circuit 55 through the power management circuit 52. The transceiver and processer circuit 55 can convert the electrical signals (e.g. voltage signals or current signals) generated from the physiological signal sensing component 54 to radio frequency (RF) signals, and wireless signals are transmitted outwards by the induction coil 51.

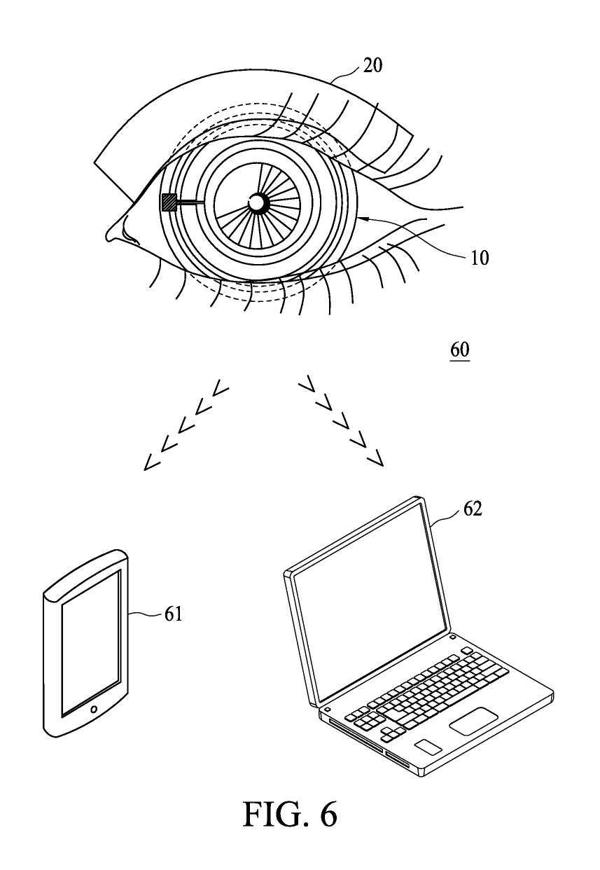

FIG. 6 is a schematic diagram of a system of power transmission to a contact lens in accordance with another embodiment of the present invention. A system uses a mobile phone 61 or a notebook computer 62 as a receiving analyzer which at least comprises a signal receiving unit and an analyzing unit. The signal receiving unit receives wireless signals transmitted from the contact lens 10. The analyzing unit may analyze and determine whether the intraocular pressure, humidity, temperature, pH, or the composition of tears is normal based on the wireless signals. The signal receiving unit may be a computer installed with specified software or an application program, a panel computer, a smart phone, a smart wrist watch or a portable device.

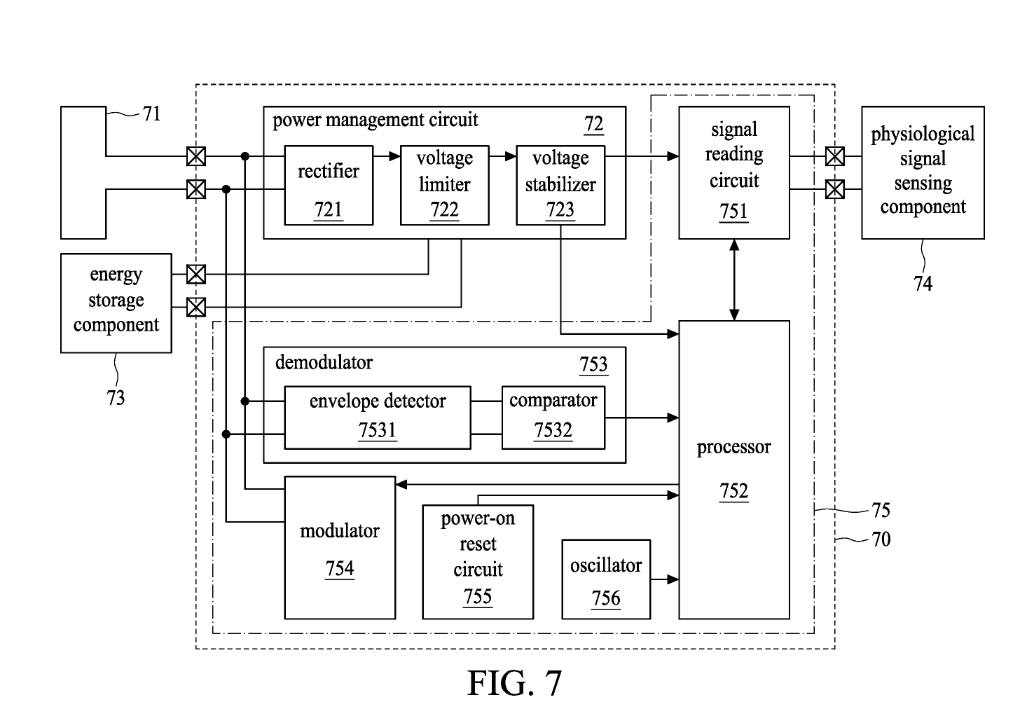

FIG. 7 is the function block diagram of a circuitry within a contact lens in accordance with another embodiment of the present invention. In view of above, when induced voltages with different directions are produced in an induction coil (or antenna) 71 during a cycle of each blink, a power management circuit 72 can convert them to a voltage with one direction through rectification, voltage limitation, and voltage stabilization. The power management circuit 72 comprises a rectifier (a full-wave rectifier or a bridge rectifier) 721 converting an induced voltage with varied polarities to one of constant polarity at its output, a voltage limiter 722 restraining the variation of the voltage, and a voltage stabilizer (a voltage regulator) 723. Thus, an energy storage component 73 can store the energy and avoid being discharged. Moreover, a signal reading circuit 751 captures physical signals (electrical signals) generated from the physiological signal sensing component 74, and further converts them into voltage signals, current signals or digital signals. The processed signals are transmitted to a processor (a microprocessor, microcontroller, or digital processor) 752 for simply conducting signal process or conversion (e.g. ADC). There are many signal processing methods such as correction, compression, decompression, encryption, and decryption, and they also may be applied to the signals for further processing.

A demodulator 753 receives the wireless signals collected by the induction coil 71 from the exterior of the contact lens, and recovers the high frequency wireless signals to low frequency signals. The wireless signals may be the control signals or other signals emitted from the mobile phone 61 or the notebook computer 62 (FIG. 6). A modulator 754 comprises an envelope detector 7531 and a comparator 7532. The modulator 754 can control or change the impedance (e.g. high impedance, medium impedance, low impedance) of the induction coil 71 to switch the induction coil 71 to generate an induced voltage or receive high frequency wireless signals from an exterior. The modulator 754 can convert the processed signals (low frequency) output from a processor 752 into high frequency wireless signals, and change the impedance of the induction coil 71 for feeding the induction coil high the frequency wireless signal to outwardly transmit them to communicate with an external receiver (the mobile phone 61 or the notebook computer 62). The processor 752 can control the operations of the signal reading circuit 751 and the modulator 754. When a transceiver and processer circuit 75 is booted, a power-on reset circuit 755 rests its interior. An oscillator 756 generates a reference clock for the processor 752 to process signals. The power-on reset circuit 755 and the oscillator 756 can be integrated into the processor 752. The modulator 754 can change the impedance of the induction coil 71, and convert low frequency signals to radio frequency (RF) signals for the induction coil 71 to transmit wireless signal outwardly by changing the impedance of the induction coil 71. The transceiver and processer circuit 75 includes the signal reading circuit 751, the processor 752, the demodulator 753, the modulator 754, the power-on reset circuit 755 and the oscillator 756. Furthermore, the power management circuit 72 and the transceiver and processer circuit 75 can be integrated into a signal and power control circuit (or chip) 70. The foregoing circuits are some examples, and may be replaced by various or similar equivalent circuits for each component or partial circuits but the application is not limit to the examples.

The foregoing embodiments of the invention have been presented for the purpose of illustration. Although the invention has been described by certain preceding examples, it is not to be construed as being limited by them. They are not intended to be exhaustive, or to limit the scope of the invention. Modifications, improvements and variations within the scope of the invention are possible in light of this disclosure.

What is claimed is:

1. A system of power transmission to a contact lens comprising:
a contact lens comprising at least a physiological signal sensing component, an induction coil, and an energy storage component electrically connected to the physiological signal sensing component and the induction coil; and
a magnetic component, wherein an induction electromotive force is produced in the induction coil for charging the energy storage component when the magnetic component has a motion relative to the induction coil.

2. The system of power transmission to a contact lens according to claim 1, wherein the magnetic component comprises a material capable of generating magnetic lines.

3. The system of power transmission to a contact lens according to claim 1, wherein the contact lens comprises a transparent material, and the physiological signal sensing component, the induction coil, and the energy storage component are embedded into the transparent material.

4. The system of power transmission to a contact lens according to claim 1, wherein the induction coil is an antenna for transmitting wireless signals.

5. The system of power transmission to a contact lens according to claim 4, further comprising a receiving analyzer for receiving and analyzing the wireless signals from the antenna.

6. The system of power transmission to a contact lens according to claim 5, wherein signal receiving unit is a computer installed with specified software or an application program, a smart phone, or a smart wrist watch.

7. The system of power transmission to a contact lens according to claim 1, wherein the physiological signal sensing component is used to measure the intraocular pressure, humidity, temperature, pH, or the composition of tears for an eye.

8. The system of power transmission to a contact lens according to claim 1, wherein the contact lens further comprises a power management circuit, and wherein the power management circuit conducts rectification, voltage limitation, and voltage stabilization for the induction electromotive force, and stores processed electrical energy in the energy storage component.

9. The system of power transmission to a contact lens according to claim 1, wherein the contact lens further comprises a transceiver and processer circuit, and the transceiver and processer circuit comprises:
a signal reading circuit capturing electrical signals generated from the physiological signal sensing component;
a processor converting the electrical signals into processed signals;
a modulator adapting the impedance of the induction coil to control the induction coil for generating the induction electromotive force, receiving high frequency wireless signals from an exterior of the contact lens or transmitting wireless signals to the exterior or being capable of converting the processed signals into high frequency wireless signals for feeding the induction coil the high frequency wireless signals to transmit outwardly; and
a demodulator receiving the high frequency wireless signals received by the induction coil from the exterior and recovering the high frequency wireless signals to low frequency signals for transmitting the low frequency signals to the processor.

10. The system of power transmission to a contact lens according to claim 1, wherein the energy storage component is a capacitor, an inductor, or a battery.

11. A method for transmitting electrical energy to a contact lens comprising the steps of:
providing a contact lens with an induction coil and a magnetic component; and
moving the magnetic component relative to the induction coil in a manner that an induction electromotive force is produced in the induction coil.

12. The method for transmitting electrical energy to a contact lens according to claim 11, wherein the magnetic component comprises a material capable of generating magnetic lines.

13. The method for transmitting electrical energy to a contact lens according to claim 11, wherein the contact lens comprises at least a physiological signal sensing component and an energy storage component electrically connected to the physiological signal sensing component and the induction coil.

14. The method for transmitting electrical energy to a contact lens according to claim 13, further comprising a step of: conducting rectification, voltage limitation, and voltage stabilization for the induction electromotive force, and storing processed currents in the energy storage component.

15. The method for transmitting electrical energy to a contact lens according to claim 13, wherein the contact lens comprises a transparent material, and the physiological signal sensing component, the induction coil, and the energy storage component are embedded into the transparent material.

16. The method for transmitting electrical energy to a contact lens according to claim 11, wherein the induction coil is an antenna for transmitting wireless signals.

17. The method for transmitting electrical energy to a contact lens according to claim 16, further comprising a step of: receiving and analyzing the wireless signals from the antenna.

18. A system of power transmission to a contact lens, comprising:
a contact lens comprising at least a physiological signal sensing component and an induction coil; and
a magnetic component, wherein an induction electromotive force is produced in the induction coil for powering the physiological signal sensing component when the magnetic component has a motion relative to the induction coil.

19. The system of power transmission to a contact lens according to claim 18, wherein the physiological signal sensing component is used to measure the intraocular pressure, humidity, temperature, pH, or the composition of tears for an eye.

20. The system of power transmission to a contact lens according to claim 18, wherein the contact lens further comprises a transceiver and processer circuit, and the transceiver and processer circuit comprises:
a signal reading circuit capturing electrical signals generated from the physiological signal sensing component;
a processor converting the electrical signals into processed signals;
a modulator adapting the impedance of the induction coil to control the induction coil for generating the induction electromotive force, receiving high frequency wireless signals from an exterior of the contact lens or transmitting wireless signals to the exterior or being capable of converting the processed signals into high frequency wireless signals for feeding the induction coil the high frequency wireless signals to transmit outwardly; and
a demodulator receiving the high frequency wireless signals received by the induction coil from the exterior and recovering the high frequency wireless signals to low frequency signals for transmitting the low frequency signals to the processor.
